(19) United States
(12) Patent Application Publication
(10) Pub. No.: US 2016/0167999 A1
(43) Pub. Date: Jun. 16, 2016

(54) METHOD FOR TREATING SULFATE-, CHLORIDE, MERCURY- AND SELENIUM-CONTAINING WASTE WATER

(71) Applicant: STEAG Energy Services GmbH, Essen (DE)

(72) Inventors: Luis Fernando Piedra-Garza, Essen (DE); Thomas Lauer, Essen (DE); Heinz-Georg Beiers, Essen (DE); Magdalena Hilger, Koln (DE); Hermann Brüggendick, Schermbeck (DE)

(21) Appl. No.: 15/048,248

(22) Filed: Feb. 19, 2016

Related U.S. Application Data
(63) Continuation-in-part of application No. PCT/EP2014/002107, filed on Jul. 31, 2014.

(30) Foreign Application Priority Data
Aug. 23, 2013 (EP) 13181513.6

(51) Int. Cl. C02F 9/00; C02F 1/28; C02F 1/52; C02F 1/66; C02F 1/44; C02F 1/42

(52) U.S. Cl. CPC C02F 9/00; C02F 1/441; C02F 1/442; C02F 1/42; C02F 1/5236; C02F 1/66; C02F 1/283; C02F 1/5245; C02F 2303/16; C02F 2101/101

(57) ABSTRACT

The method according to the invention provides a method for treating a waste water, where (a) the waste water is provided having specific sulfate, chloride, mercury, and selenium concentrations, (b) the waste water (WW) is fed to a high pressure separator 1 using a high-pressure pump (P1) in which the waste water (WW) is separated into a permeate volume (PV) containing reduced sulfate, chloride, mercury, and selenium concentrations and a concentrate volume (CV), (c) and where the concentrate volume (CV) is separated using a cleaning apparatus 4 that reduces both mercury and selenium in the concentrate volume.

### CROSS REFERENCE TO RELATED APPLICATION

This application is a continuation-in-part of International Application No. PCT/EP2014/002107, filed Jul. 31, 2014, which claims priority to EP Application No. 13181513.6, filed Aug. 23, 2013, the entire contents of which are incorporated herein by reference.

### FIELD

The present invention relates to a method for the treatment of sulfate-, chloride-, mercury- and selenium-containing waste water and in particular to a method for treating waste water of flue gas desulfurization plants.

### BACKGROUND

The combustion of fossil fuels results in the production of flue gases which contain pollutants that must be removed prior to venting the flue gas to the atmosphere.

A group of pollutants are the sulfur oxides, which are created during combustion due to the presence of sulfur in the coal, and which are usually removed with a flue gas desulfurization plant. Modern fossil fuel power plants rely on large amounts of fossil fuels in order to generate sufficient power, and thus the resulting combustion process produces gas quantities that are substantial. Consequently appropriately sized flue gas desulfurization plants must be constructed to process the corresponding volume of gas.

A distinction is generally made between regenerative and non-regenerative processes for the desulfurization. For cost reasons, the non-regenerative processes, and particularly wet processes, have prevailed for flue gas desulfurization. In these wet processes, methods using one or more alkaline (e.g., NaOH) solutions or earth alkaline (e.g., lime (Ca(OH)₂) or limestone ((CaCO₃) slurry) reagents to bind the sulfur oxides have prevailed. For this, the flue gases are directed to an absorber, in which they are sprayed with reagent containing water and in which the sulfur oxides from the flue gases pass into solution and react with the reagent. In case of using lime or limestone as a reagent, the calcium sulfite (CaSO₃) generated in the suspension is optionally oxidized by bubbling air through the suspension and the result is a gypsum (CaSO₄) slurry. From this slurry, the gypsum is removed and can be used as raw material in the construction industry.

The waste water generated in the flue gas desulfurization plant described above contains significant amounts of dissolved sulfate and contaminants such as chloride, mercury and selenium, which are extracted from the flue gases in the flue gas desulfurization process. The waste water from a flue gas desulfurization plant cannot therefore simply be discharged to the environment, but must be cleaned before release. In particular, the near complete removal of mercury and selenium is important. Due to the considerable amount of waste water generated, appropriately sized cleaning systems are required, but the construction and operation of these systems are very costly.

It is therefore the objective of the present invention to provide a method for treating waste water, e.g., from a flue gas desulfurization plant, without high investment costs or process complexity while adhering to very strict environmental limits for the generated treated effluent that can be discharged to the environment and/or re-used in the process.

### SUMMARY

According to the invention a method for treating waste water is provided, having the steps of (a) providing a waste water (WW) of the flue gas desulfurization plant having a specific sulfate, chloride, mercury and selenium concentration, (b) feeding the waste water (WW) through a high-pressure pump (P1) to a high pressure separator 1 in which the waste water (WW) is separated into a permeate volume (PV) containing reduced sulfate, chloride, mercury and selenium concentrations, and a concentrate volume (CV), (c) feeding the concentrate volume (CV) to a cleaning apparatus 2 in which the mercury and the selenium concentration of the concentrate volume (CV) is reduced.

According to the present invention for the treatment of waste water generated by a flue gas desulfurization plant, a waste water generated by the flue gas desulfurization plant containing sulfate, chloride, mercury and selenium is provided. This waste water is fed via a high pressure pump into a high pressure separator where the waste water is separated into a permeate volume with a reduced sulfate, chloride, mercury and selenium concentration and a concentrate volume. The concentrate volume is supplied to a cleaning apparatus, where the mercury and selenium concentration of the concentrate volume is reduced. Potentially the concentration of other pollutants contained in the concentrate volume can be reduced as well.

Although high-pressure separators have long been used, it was surprisingly found that they are suitable for the separation of mercury and selenium compounds from waste water of a flue gas desulfurization plant, i.e. the separation of mercury and selenium with an appropriate separation device, even in spite of the significant sulfate concentration of the waste water, is possible. This is particularly surprising since it is well known that sulfates interfere in the separation of mercury and selenium, and the sulfate concentration in the waste water of flue gas desulfurization plants is usually well within the range of the solubility limit.

When passing the waste water through the high pressure separator a permeate volume with a reduced sulfate, chloride, mercury and selenium concentration and a concentrate volume that shows as a minimum an increase in the selenium concentration is obtained and only the concentrate volume is fed to the cleaning apparatus since the concentrations of pollutants in the permeate volume are so small that the water can be discharged to the environment and/or re-used in the process.

Since the sulfate concentration of the waste water is usually in the range of the solubility limit, no increase in sulfate concentration is to be observed. It is to be assumed that sulfate is deposited within the separator when separating the permeate volume and the concentrate volume. In some cases even a decrease of the sulfate concentration in the concentrate is observed.

The same applies to mercury deposition. Although the mercury concentration in the permeate volume is significantly lowered, the concentrate volume itself does not see a corresponding increase in mercury concentration (and it is likely to be lower than in the waste water), so that in terms of mercury, it can be assumed that it (at least partially) settles in the high-pressure separator.

Typically, high pressure separating devices are operated in a ≧50:≦50 ratio, i.e. the waste water is split into ≧50% vol. permeate volume and ≦50% vol. concentrate volume. At a constant flue gas flow and employing a constant flue gas desulfurization cleaning process, in accordance with an embodiment of the invention, only ≦50% of the usual waste water is fed to the cleaning apparatus which results in a significantly reduced cleaning device and operating costs.

In a specific embodiment of the invention at least one reverse osmosis device with at least one reverse osmosis module is used as the high-pressure separator. The handling of reverse osmosis devices has long been known, so the use of such devices is particularly simple. The high pressure separator comprises at least the reverse osmosis device which in turn comprises at least one reverse osmosis module in which the waste water is separated into a permeate volume with a reduced sulfate, chloride, mercury and selenium concentrations and a concentrate volume. Depending on the size of the cleaning device and thus on the amount of waste water, a combination of reverse osmosis modules can be used, which are then preferably connected in parallel, preferably having the ability to place each individual unit in and out of service depending on the amount of waste water.

It has surprisingly been found that separation of the waste water into a permeate volume with a reduced sulfate, chloride, mercury and selenium concentration as well as a concentrate volume can be achieved by employing a nanofiltration device. In an alternative embodiment of the invention a nanofiltration device with at least one nanofiltration module is used as the high pressure separator, wherein the high pressure separator can comprise additional components.

The stipulations on residual concentration of mercury and/or selenium in waste water released to the environment vary depending on the country, and experience has shown that these requirements are constantly increasing with time. To achieve further reduction of the mercury and selenium concentration in the permeate volume, a separator comprising a nanofiltration device and a reverse osmosis device are a preferred embodiment of the invention. Here the waste water is separated into a nano-permeate volume and a nano-concentrate volume. The nano-permeate volume is fed to the reverse osmosis device and is separated into a permeate volume and a concentrate volume. Finally, the nano-concentrate volume and concentrate volume of the reverse osmosis device are fed into the cleaning apparatus, in which the concentration of mercury and selenium in the concentrate volume is reduced.

This specific embodiment of the invention will result in an increased volume of waste water leaving the high pressure separator that is fed to the cleaning apparatus, meaning the amount of waste water which is to be fed to the cleaning apparatus for treatment is greater as compared to the employment of a standalone reverse osmosis device. However, the concentration of mercury and selenium in the permeate volume which leaves the high pressure separator is further reduced so that more stringent requirements for residual concentrations of mercury and selenium in the water to be discharged can be met.

When using a reverse osmosis and/or nanofiltration device for separating the waste into a low-pollutant concentration permeate and a concentrate volume, it is sometimes necessary, during operation, to clean or flush the membranes of the reverse osmosis module(s) or the nanofiltration module(s) itself, since solids can settle out during operation. In this process, water is added if necessary, with suitable additives, and flushed through the membranes and the module to dissolve solids and to remove them from the membranes and to wash out the membranes.

In order not to interrupt the process, a specific embodiment of the present invention describes that in the reverse osmosis and/or nanofiltration device several parallel lines be provided, each having at least one reverse osmosis or nanofiltration module, so that the lines can be switched on or off individually.

If, during this process flow, cleaning of the membrane(s) of the reverse osmoses module(s) or the nanofiltration module(s) itself located in a first line is necessary, this first line can be taken out of service, a second line can be switched on and the first line can be cleaned.

Depending on the length of time it takes to complete a cleaning process, it can be useful to provide not only two, but three or more parallel lines, since this ensures that the maximum purification capacity of the separator is used by operating as many modules and parallel lines simultaneously.

The reverse osmosis or nanofiltration modules, or a line with at least one module, can be taken out of service time dependent and rinsed or cleaned. A specific embodiment of the invention allows for that a reverse osmosis or nanofiltration module or a line with at least one reverse osmosis module to be automatically purged or cleaned as a function of predetermined parameters, so that a purging/cleaning is carried out only when necessary given the predetermined parameters of the system.

For purging and cleaning, respectively, of the module(s) or the membranes of the reverse osmosis, it is necessary to use water with reduced sulfate, chloride, mercury and selenium concentrations compared to the waste water that is to be separated and cleaned.

In a specific embodiment of the invention at least a part of the permeate volume and/or nano-permeate volume having a reduced sulfate, chloride, mercury and selenium concentration as compared to the waste water are cached. The reverse osmosis module and nanofiltration module respectively or line of at least one module is rinsed with cached permeate volume. Thus, the fresh water consumption for flushing or cleaning of the separation device is reduced or it can even be avoided completely, if enough permeate is cached in the system.

Generally, flue gas desulfurization waste water is not regularly loaded with solids, as these (particular gypsum) are separated before leaving the flue gas desulfurization plant. It may happen that due to decreased or increased throughput of the flue gas desulfurization pant, minor amounts of solids are discharged with the waste water. In order to prevent these solids from depositing in the high pressure separator, a preferred embodiment of the invention provides that solids will be removed from the waste water before the waste water is separated into a permeate volume and a concentrate volume.

Even though the waste water is completely free of solids, solids will form on the membranes of the reverse osmosis module or in the nanofiltration module with time. In order to prevent the formation of solids, or at least slow down the process, a preferred embodiment of the invention describes the addition of antiscaling agents and/or an acid to the waste water prior to separation into a permeate volume and a concentrate volume.

During operation of a pilot plant analysis of the membranes in the reverse osmosis module or nanofiltration module respectively have indicated that in particular sulfate and, surprisingly, iron compounds are deposited in or on the membranes or modules, thus making flushing or cleaning necessary. To prevent such sticking of sulfates and iron compounds, it is a preferred embodiment of the invention to remove sulfates and/or iron compounds from the waste water before it is separated into a permeate volume and a concentrate volume.

Whether a nanofiltration device, or a reverse osmosis device is used as a high-pressure separator the sulfate, chloride, mercury and selenium concentration of the permeate volume and/or nano-permeate volume is reduced compared to the waste water generated by the flue gas desulfurization system. Therefore, it is a preferred embodiment of the current invention to return the permeate volume and/or nano-permeate volume to the flue gas desulfurization plant for reuse. Alternatively, the permeate volume and/or the nano-permeate volume may be used in other sections of the process or other process components. A corresponding process control has the advantage that the flue gas desulfurization plant, or any other portion in the process procedure, can be operated with reduced quantities of fresh water which provides for a more economical process. Alternatively or in addition, at least a portion of the waste water leaving the cleaning apparatus can be fed to the flue gas desulfurization plant or any other process component and reused.

In the cleaning apparatus, the concentration of mercury and selenium in the concentrate volume is reduced. This can be carried out using any desired method known to a person skilled in the art. In a preferred embodiment of the invention it is, however, provided that the mercury and selenium concentration of the concentrate volume is reduced in the cleaning device by precipitating BaSO₄ from the supplied concentrate volume by adding a defined amount of Ba²⁺-ions to the concentrate volume and removing the resulting BaSO_{4.} The resulting low-solids concentrate volume is fed to an ion exchanger for the removal of mercury, wherein a concentrate volume with a reduced mercury content is obtained, and selenium and/or selenium compounds are removed from the concentrate volume.

Through the above steps, mercury and selenium can be removed from the concentrate volume economically and with simple plant design. The inventive sequence of the process steps is effective for the removal of mercury and selenium in sulfate loaded waste water without high investment costs or process complexity while adhering to very strict environmental limits.

The sulfate concentration of the concentrate volume is substantially reduced by precipitation, i.e. as barium sulfate, in a first process stage (Sulfate Precipitation Stage) which provides for a sulfate reduced waste water which now allows for subsequent removal of mercury (Mercury Stage) and selenium (Selenium Stage). When using a reverse osmosis device with a nanofiltration device upstream (see above), the sulfate precipitation stage for the reverse osmosis concentrate volume can be omitted since the sulfate concentration was already sufficiently lowered in the nanofiltration so that the remaining sulfate (also in the concentrate volume of the reverse osmosis system) does not interfere with the subsequent removal of mercury and selenium.

For the precipitation of barium sulfate in the concentrate volume, of which the sulfate concentration is known, a defined amount of Ba²⁺ ions (for example, a Ba²⁺-containing solution of known Ba²⁺ concentration or a water-soluble solid comprising Ba²⁺ ions) is added so that BaSO₄, which has a low solubility of 1.08*10⁻¹⁰ mol²/L², precipitates from the solution. Because the concentration of the sulfate, the concentration/amount of Ba2+-containing solution, and the concentration of the solid are known this process stage may be performed in a way such that barium is supplied in precisely stoichiometric amounts to the concentrate volume. If the sulfate concentration is not known or varies widely, it will be determined before the sulfate precipitation. Other sulfate precipitation methods (e.g., with calcium aluminate) are also know and possibly suitable.

As mentioned above, after the removal of mercury through an ion exchanger, selenium and/or selenium compounds are removed from the concentrate volume with reduced mercury content. In a preferred embodiment of the invention, this is achieved by employing an iron mixture with Fe (0) and Fe (II) and Fe (III) compounds to the concentrate volume with reduced mercury content. Preferably powdered Fe (0) is added. Subsequently the pH is adjusted to between a pH-value of 6 and 8.5 preferably between 7.0 and 8.0 and selenium or selenium-containing solids are separated from the solution.

Selenium is present in the concentrate volume and predominantly found in oxidation state (VI), or as selenate ion (SeO₄²⁻). It is understood that selenate reacts with the iron or iron mixture, presumably for the formation of, among others, Fe^{II}₄Fe^{III}₂(OH)₁₂SeO₄×nH₂O, which precipitates as a solid. Precisely which and at what time selenium-containing solids or mixtures of solids are created is not yet exactly clear and not essential for the invention.

Especially when processing large amounts of waste water, it is desirable to carry out the precipitation and separation of the different solids quickly.

Surprisingly, it was found that the precipitation of selenium and selenium-containing solids takes place particularly rapidly when an iron mixture comprising Fe (0), Fe (II) and Fe (III) compounds is added, wherein it is preferred that Fe (0) is added in a powdered form. The mixing ratio of Fe (0), Fe (II) and Fe (III) will depend on the particular concentration of selenium in the waste water.

In this way, the deposition of selenium or selenium-containing solids takes place over a surprisingly short time period compared to known methods and thus allows for a much better process control.

With the process stage for separation of selenium from the waste water as described above, a concentration of selenium <15 μg per liter of waste water can be achieved.

The invention further relates to the use of a reverse osmosis device, or a nano-filtration device for separation of a waste water into a permeate volume with reduced sulfate, mercury and selenium concentrations and a concentrate volume having increased sulfate, mercury and selenium concentrations.

### BRIEF DESCRIPTION OF THE DRAWINGS

The following exemplary methods are described with reference to the drawing, wherein

FIG. 1 depicts a first embodiment of the invention,

FIG. 2 depicts a second embodiment of the invention,

FIG. 3 depicts a third embodiment of the invention, and

FIG. 4 depicts the removal of sulfate, mercury and selenium from a concentrate volume in detail.

### DETAILED DESCRIPTION

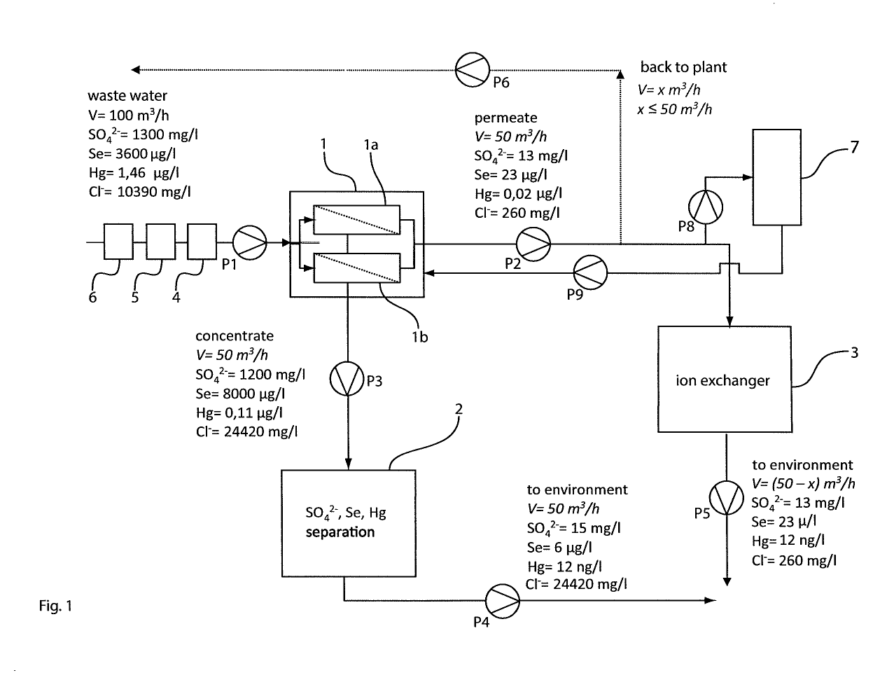

FIG. 1 shows a preferred embodiment of the invention. In this embodiment of the invention, a reverse osmosis device is part of a high-pressure separator 1. The reverse osmosis device comprises two parallel lines each having a reverse osmosis module 1a, 1b, wherein the individual lines may be switched on or off. The high pressure separator 1 is provided via a high-pressure pump P1 with a waste water WW, wherein in the case of the presented embodiment a waste water at 100 m³/h is provided. The waste water is generated by a flue gas desulfurization plant and contains (for the description of this embodiment) 1300 mg/L sulfate, 3600 μg/L selenium, 1.46 μg/L mercury and 10390 mg/L chloride (see Table 1).

TABLE 1
Substance concentrations in the waste water, permeate(s), concentrate(s)

| | | | |
|---|---|---|---|
| Sulfate | Selenium | | Chloride |
| (mg/L) | (μg/L) | Mercury (μg/L) | (mg/L) |

High pressure separator with reverse osmosis device

| | | | | |
|---|---|---|---|---|
| Waste water | 1300 | 3600 | 1.46 | 10390 |
| Concentrate | 1200 | 8000 | 0.11 | 24420 |
| Permeate | 13 | 23 | 0.02 | 260 |

High pressure separator with nanofiltration device

| | | | | |
|---|---|---|---|---|
| Waste water | 1400 | 4000 | 1.44 | 10150 |
| Concentrate | 1400 | 7900 | 0.10 | 18100 |
| Permeate | 20 | 35 | 0.02 | 3930 |

High pressure separator with nanofiltration and reverse osmosis devices

| | | | | |
|---|---|---|---|---|
| Waste water | 1400 | 4000 | 1.44 | 10150 |
| Nano-concentrate | 1400 | 7900 | 0.10 | 18100 |
| Nano-permeate | 20 | 35 | 0.02 | 3930 |
| (Feed reverse osmosis) | | | | |
| Osmosis concentrate | 40 | 68 | 0.04 | 7800 |
| Osmosis permeate | 1 | 1 | 0.005 | 150 |

After leaving the flue gas desulfurization plant, the waste water is passed through a device 6 for the separation of solids which may have been carried over by the waste water leaving the flue gas desulfurization plant. Typically, the waste water WW leaving the flue gas desulfurization plant is largely free of solids, so that the device 6 to remove solids is only optional and best used when the suspended solids are increased.

After the device 6 for the reduction of solids, the waste water is treated further in device 5 with an antiscaling agent and/or an acid in order to avoid or slow down the deposition of solids on the membranes of the reverse osmosis modules. Whether an antiscaling agent and/or an acid is added depends on the exact composition of the waste water and is therefore not absolutely necessary. Finally, sulfate and/or iron compounds are separated from the waste water in a device 4, since it has been shown that sulfates and iron compounds are preferentially deposited on the membranes of the reverse osmosis modules. Whether sulfate and/or iron compounds are separated depends on the exact composition of the waste water. The aforementioned devices 6-4 can be arranged in any order, and can even be combined into a single device.

The waste water is passed through the high pressure separator 1 with two parallel lines each having one reverse osmosis module. These reverse osmosis modules are adjusted so that the fed waste water is separated into a permeate volume PV of at least 50% and a concentrate volume CV of no more than 50%. The two parallel lines can operate at the same time. Depending on various other parameters only one line can be in operation and the other shut down for cleaning purposes such that the entire waste water is separated by one line. The number of lines used depends on the waste water itself as well as the frequency of the need for purification of the individual reverse osmosis modules, i.e. if frequent cleaning of the reverse osmosis modules is required due to the composition of the waste water, it may be appropriate to use a large number of parallel-connected lines.

In the high pressure separator 1, the waste water supplied via high pressure pump P1 is separated into a permeate volume PV and a concentrate volume CV. In the permeate volume PV, the sulfate concentration is 13 mg/L, the selenium concentration 23 μg/L, the mercury concentration 0.02 μg/L and the chloride concentration is 260 mg/L. In all of the aforementioned compounds, a significant reduction in the concentration as compared to the waste water WW is observed (Table 1).

Also in the concentrate volume CV a reduction of the sulfate concentration to 1200 m/L is observed, which is probably due to the fact that a part of the sulfate has settled on the membranes of the reverse osmosis modules. The selenium concentration almost doubled to 8000 μg/L, which is consistent with the significant reduction in the permeate volume and a separation efficiency of 50%. The mercury concentration in the concentrate volume is reduced to 0.11 μg/L, wherein it is assumed that also a part of the mercury compounds have also been deposited on the membranes of the reverse osmosis modules. The concentration of chloride in the concentrate volume is 24420 mg/L and is thus to some extent also twice as high as in the waste water.

The concentration of selenium and mercury in the permeate volume may now be already so low already that the permeate can be discharged (depending on the country-specific requirements) to the environment without further purification. If the discharge limit with regards to the concentration of mercury is still exceeded, the permeate may be fed to an ion exchanger by means of pump P2 in which the mercury concentration is significantly reduced again, resulting in a concentration of 12 ng/l. The purified permeate can then be discharged to the environment, over pump P5, without any further purification.

Since sulfate, chloride, selenium and mercury are in low concentrations in the permeate as compared to the waste water, the treated water or a portion of it can be fed back into the desulfurization process or to an upstream process and be re-introduced into the process, which will considerably save on the amount of freshwater otherwise consumed by the process. Because of the aforementioned substantial reduction in pollutants inherent to the permeate, at least partial recirculation of the permeate will not result in elevated concentration of pollutants.

The presented embodiment of the invention also allows the supply of a part of the permeate volume to tank 7 over pump P8. When cleaning the reverse osmosis modules is necessary, the permeate cached in the temporary storage tank 7 can be fed to the high pressure separator via pump P9 and purge the membranes.

The concentrate volume CV is fed by pump P3 to device 2 for the deposition of sulfate, selenium, and mercury. The deposition of the above compounds can be carried out by using various methods known to the person skilled in the art.

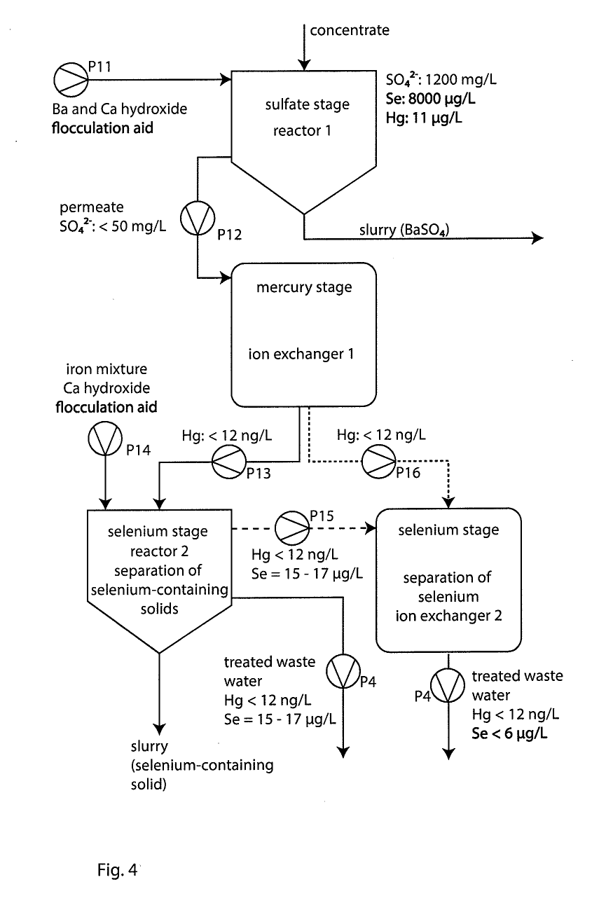

A particularly efficient removal of sulfate, selenium, and mercury from the waste water is described in detail in the sections below with respect to FIG. 4.

### Separating Sulfate, Selenium, and Mercury

Turning now to FIG. 4, with pump P11, Ba- and Ca- hydroxide and a flocculation aid are added to the concentrate volume. The resulting solid, which comprises mainly barium sulfate, but, depending on the amount of precipitant added to the solution, may also contain barium selenate and other solids, is separated and recycled or disposed of depending on the solid's purity.

The sulfate-poor concentrate volume is supplied by pump P12 to a mercury stage with an ion exchanger 1 in which mercury is removed to a concentration of <12 ng/L, resulting in a concentrate volume with decreased mercury content. The ion exchanger employs normal resins used for the removal of mercury from water.

The volume of reduced mercury concentrate can be fed by pump P13 to reactor 2 to the selenium stage for the separation of selenium and other selenium-containing solids. In reactor 2, a mixture of iron, calcium hydroxide and a flocculation aid (the exact details are shown below) are supplied over pump P14 to the concentrate volume under constant mixing. After a predetermined reaction time, the resulting solids are removed from the concentrate volume. The concentrate volume has (depending on the exact reaction condition) a mercury concentration of <12 ng/L and a selenium concentration of about 15 μg/L.

If the residual concentrate concentrations meet local discharge limits, the volume may be discharged into the environment by means of a pump P4 (as shown in FIG. 1).

If the concentrate requires further reduction of the residual selenium concentration, the concentrate volume may alternatively be fed via pump P15 to an ion exchanger 2. In the ion exchanger 2 selenium is reduced to a residual concentration of <6 μg/L. The effluent of ion exchanger 2 may then be released to the environment.

The concentrate volume with the decreased mercury content may be fed, alternatively, if for example the selenium concentration is relatively small, directly (and without detour over the selenium separation for precipitation of selenium-rich compounds) by way of pump P16 to the ion exchanger 2. The discharge of ion exchanger 2 may also in this case be released to the environment.

If the effluent of ion exchanger 2 or reactor 2 of the selenium precipitation stage is still heavily burdened with barium, because for example, if an excess-stoichiometric quantity of precipitants was added in the sulfate precipitation stage, the discharge of ion exchanger 2 or of reactor 2, which is to be released to the environment, may be retreated with sulfate, in order to precipitate residual concentrations of barium as barium sulfate. Barium sulfate is, depending on its quantity, separated prior to removal/discharge. If the discharge of ion exchanger 2 or reactor 2 is recycled, the separation of barium may not be necessary; however, it may take place as indicated above.

Selenium deposition is described in more detail in the next section as an essential part of cleaning the concentrate volume.

### Deposition of Selenium by Precipitation

In the selenium precipitation stage, selenium or selenium-containing compounds are separated. In order to gain an optimal separation result, many laboratory tests were performed for the selenium precipitation stage, of which the results are given in Table 2 as shown below. Below are the details for the individual experiments and trials, particularly with regard to the impact of changing various process parameters and varying initial concentrations as indicated.

A mixture of metallic powders of iron (≧99% purity), FeCl₂×4H₂O(≧99%) and FeCl₃×6H₂O(≧98%) (“Iron Mix” in Table 2) in various ratios and amounts was added to a concentrate volume containing a reduced mercury content (from the mercury stage). Samples were taken every hour and a determination of selenium in accordance with DIN EN ISO 17294-2 (ICP-MS) was made.

TABLE 2
Selenium deposition with various iron compound mixtures

| | | | | Addition of Ca(OH)₂ 20% by | Se in waste |
|---|---|---|---|---|---|
| Test No. | Time (h) | Iron mixture | Iron mixture added (mL) | weight suspension | water (μg/L) |
| 12 | 2 | Fe + FeCl₂ + FeCl₃ | 51 (to pH 4) | to pH 10.8 | 70 |
| | | (0.5 g + 5 g + 5 g @ 500 mL) | | | |
| 13 | 2 | Fe + FeCl₂ + FeCl₃ | 60 (to pH 4) | to pH 6-7 | 53 |
| | | (0.5 g + 5 g + 5 g @ 500 mL) | | | |
| 14 | 1 | Fe + FeCl₂ + FeCl₃ | 50 (to pH 4) | to pH 11 | 45 |
| | | (0.5 g + 5 g + 5 g @ 500 mL) | | | |
| 15 | 2 | Fe + FeCl₂ + FeCl₃ | 0 | 0 | 48 |
| | | (0.5 g + 5 g + 5 g @ 500 mL) | | | |
| 16 | 3 | Fe + FeCl₂ + FeCl₃ | 0 | 0 | 47 |
| | | (0.5 g + 5 g + 5 g @ 500 mL) | | | |
| 17 | 4 | Fe + FeCl₂ + FeCl₃ | 0 | 0 | 47 |
| | | (0.5 g + 5 g + 5 g @ 500 mL) | | | |
| 18 | 1 | Fe + FeCl₂ + FeCl₃ | 100 (to pH 3.3) | to pH 8 | 15 |
| | | (1 g + 10 g + 10 g @ 500 mL) | | | |
| 19 | 2 | Fe + FeCl₂ + FeCl₃ | 0 | 0 | 15 |
| | | (1 g + 10 g + 10 g @ 500 mL) | | | |
| 20 | 3 | Fe + FeCl₂ + FeCl₃ | 0 | 0 | 17 |
| | | (1 g + 10 g + 10 g @ 500 mL) | | | |
| 21 | 1 | Fe + FeCl₂ + FeCl₃ | 150 (to pH 3.1) | to pH 7.4 | 15 |
| | | (1 g + 10 g + 10 g @ 500 mL) | | | |
| 22 | 2 | Fe + FeCl₂ + FeCl₃ | 0 | 0 | 16 |
| | | (1 g + 10 g + 10 g @ 500 mL) | | | |
| 23 | 3 | Fe + FeCl₂ + FeCl₃ | 0 | 0 | 17 |
| | | (1 g + 10 g + 10 g @ 500 mL) | | | |
| 24 | 1 | Fe + FeCl₂ + FeCl₃ | 100 (to pH 2.7) | to pH 8.0 | 36 |
| | | (1 g + 20 g + 25 g @ 500 mL) | | | |
| 25 | 2 | Fe + FeCl₂ + FeCl₃ | 20 (up to pH 8.2) | 0 | 30 |
| | | (1 g + 20 g + 25 g @ 500 mL) | | | |
| 26 | 3 | Fe + FeCl₂ + FeCl₃ | 0 | 0 | 32 |
| | | (1 g + 20 g + 25 g @ 500 mL) | | | |

As Table 2 shows, the influence of the reaction time played a minor role (Experiments 14-23), and the residual selenium concentration varied only slightly with reaction times of 1 to 3, or 4 hours, respectively.

The influence of pH, however, was surprisingly large. There were relatively large variations in the selenium concentration detected between pH 7-11.

The pH of the concentrate volume with reduced mercury content was about 6.5. After the addition of the respective iron mixture, the pH dropped to about 3-4. A 20% by weight suspension of Ca(OH)₂ was added for subsequent pH adjustments.

An increase in the pH to about 11 did not result in residual low selenium concentrations. It was found that in nearly neutral to slightly alkaline conditions (pH 7.4 to 8.0; trials 18-23) the greatest selenium deposition (residual concentration of selenium 15 μg/L) was achieved.

The ratio Fe (0)/Fe (II)/Fe (III) 1:10:10 (experiments 18-23) proved to be optimal. As a comparison of Experiments 18-20 and 21-23 show, the addition of more iron mixture showed no further lowering of the residual selenium concentration.

The experimental results shown in Table 2 are all related to iron compounds mixtures containing iron chloride compounds since these compounds gave the best results for the selenium deposition.

### Slow Addition of Iron Mixture (Experiments 18-20)

(The Best-Known Approach for Selenium Deposition)

To the volume of concentrate with a reduced mercury content (effluent of the mercury stage) a 100 ml suspension of iron mixture in water (see experiments 18-20) was added slowly (and depending on the volume, for example over a period of 5 minutes) until a pH of approximately 3.0-3.5 was reached. Subsequently a 20 wt % calcium hydroxide suspension was added to adjust the pH to around approximately 8. An adapted amount of polyacrylamide was added, simultaneously, as a flocculation aid. The suspension was then stirred for 3 hours and the solid was separated. After each hour samples were measured to determine the resulting selenium concentration.

The effluent from the selenium deposition by means of solid separation can then either be fed to the selenium separation stage with ion exchange or it can be released into the environment.

### Process Parameters:

Solution with reduced mercury content (from Hg-stage)
V=1L, T=25° C., p=1 atm, pH=6.0-7.0.
Reaction Time:
60 min
Chemicals
   100 mL (20 mL/min) of an iron-containing solution ^{[1]} is added to 1 L solution of Hg-stage (pH after addition: 3.0-3.5)
   Ca(OH)₂ (>95% ACS, CAS 1305-620) 20%-wt. Suspension was added until a pH of 7.5 to 8.0 was reached, together with 1 mL of polyacrylamide (50% by weight aqueous solution, CAS 9003-05-8)
   [1] 1 g of Fe (99%, powder, CAS 7439-89-6), 10 g of FeCl₂·4H2O (≧99%, CAS 13478-10-9) and 10 g of FeCl₃·6H2O (≧99%, CAS 10025-77-1) in 500 mL of deionized water.

Table 3 shows the experimental results of these comparative experiments under different test conditions. The selenium precipitation was investigated with a known iron mixture (experiments 1-3) which was comprised of Fe (0) and Fe (II) and with an iron mixture consisting of Fe (0), Fe (II) and Fe (III) as described in the invention.

TABLE 3
Comparison of tests for selenium deposition

| | | | Se (μg/L) | Se (μg/L) | |
|---|---|---|---|---|---|
| Trial | | pH- | before | after | % |
| No | Iron mixture | adjusted | deposition | deposition | Capture |
| 1 | Fe (0) + FeCl₂ | 6.0 | 380 | 330 | 13.16 |
| | (1:10) | | | | |
| 2 | Fe (0) + FeCl₂ | 7.0 | 270 | 220 | 18.52 |
| | (1:10) | | | | |
| 3 | Fe (0) + FeCl₂ | 8.0 | 323 | 184 | 43.03 |
| | (1:10) | | | | |
| 4 | Fe (0) + FeCl₂ + FeCl₃ | 6.0 | 323 | 95.4 | 70.46 |
| | (1:10:10) | | | | |
| 5 | Fe (0) + FeCl₂ + FeCl₃ | 7.0 | 323 | 104 | 67.80 |
| | (1:10:10) | | | | |
| 6 | Fe (0) + FeCl₂ + FeCl₃ | 8.0 | 331 | 14.5 | 95.62 |
| | (1:10:10) | | | | |

Surprisingly, the use of the iron mixture described in the present invention had a very significant and unexpected effect on the selenium deposition.

Related to pH value 8, at which the selenium separation was its largest with both test series, the iron mixture with the preferred composition as described by the present invention, causes an increase in selenium separation by a factor of 10 at a reaction time of one hour. It is apparent from Table 3, that the effect of improved selenium deposition is also achieved with different compositions of the iron mixture, but did not outperform the preferred method using the iron mixture composition of the present invention.

When using the iron composition of the present invention, the selenium deposition can thus be performed much faster and therefore more cost effectively.

Selenium Removal with an Ion Exchanger

With the aforementioned method for selenium deposition by separation of solids, a residual solid concentration of <15 μg/L can be achieved. If discharge limits are more stringent, the approach specified above is not sufficient.

Alternatively (or in addition to the selenium deposition via separation of solids), selenium can be removed with an ion exchanger. The feed water used for this step may be the discharge from the mercury separation stage or the waste water of the selenium deposition via separation of solids described above.

To obtain a selenium concentration in the treated solution of <6 μg/L, the ion exchange resin DOWEX Marathon A2 was used. According to the manufacturer, this resin is capable of removing anions from waste water with a high chloride ion content. This is particularly advantageous if selenium has been separated previously using the iron mixture. The resin consists of dimethylethanolamine as a functional group, which is associated with strongly alkaline ion exchange resins.

Similar to the mercury stage, a 1.5 L column was filled with 0.5 L ion exchange resin DOWEX Marathon A2 through which the flow rate was 1 L/h. Samples were taken periodically from a collection vessel and mixed. The composite sample was then sent to an analytical laboratory. The residual selenium concentration of the mixed sample was <5 μg/L. Further details could not be determined because 5 μg/L is the analysis detection limit for selenium by ICP-MS.

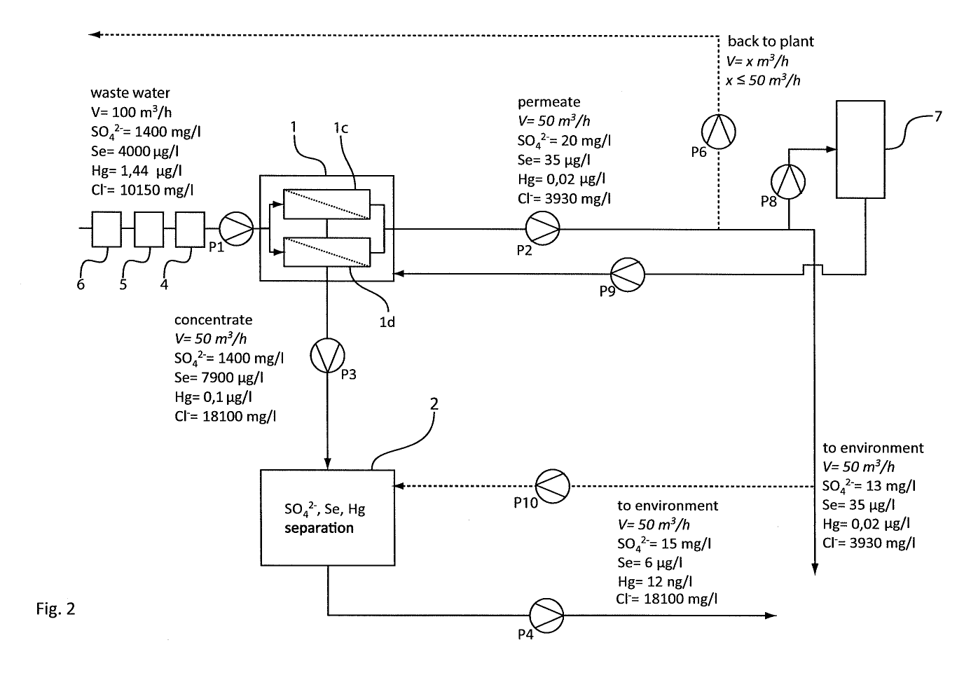

FIG. 2 shows a second preferred embodiment of the present invention. In this embodiment a nanofiltration device is introduced as part of high pressure separator 1, wherein the nanofiltration device comprises two parallel operated nanofiltration modules 1c, 1d.

The information regarding the concentrations of sulfate, chloride, mercury and selenium in the waste water, in the permeate volume as well as in the concentrate volume, is shown in Table 1. This data proves that even when using a nano-filtration device, the permeate volume PV leaving the high pressure separator exhibits substantially decreased concentrations of the aforementioned compounds. The actual procedure essentially corresponds to that shown in FIG. 1 but with the specific embodiment of the present invention a subsequent purification of the permeate volume using an ion exchange system can be forgone. Further cleaning of the permeate volume can be forgone only if mercury and/or selenium concentrations are under the country-specific discharge limit; if this is not the case, an additional cleaning must take place, in which, as described in FIG. 1, the ion-exchange procedure (for mercury) is carried out or any other method know to a person skilled in the art.

Alternatively, the permeate may be fed to an apparatus 2, for example, by a pump P10, in which the sulfate precipitation can be bypassed because the concentration of the sulfate is already low enough in the permeate. In order to avoid unnecessary repetition a detailed described of the second preferred embodiment of the invention is not further reiterated here.

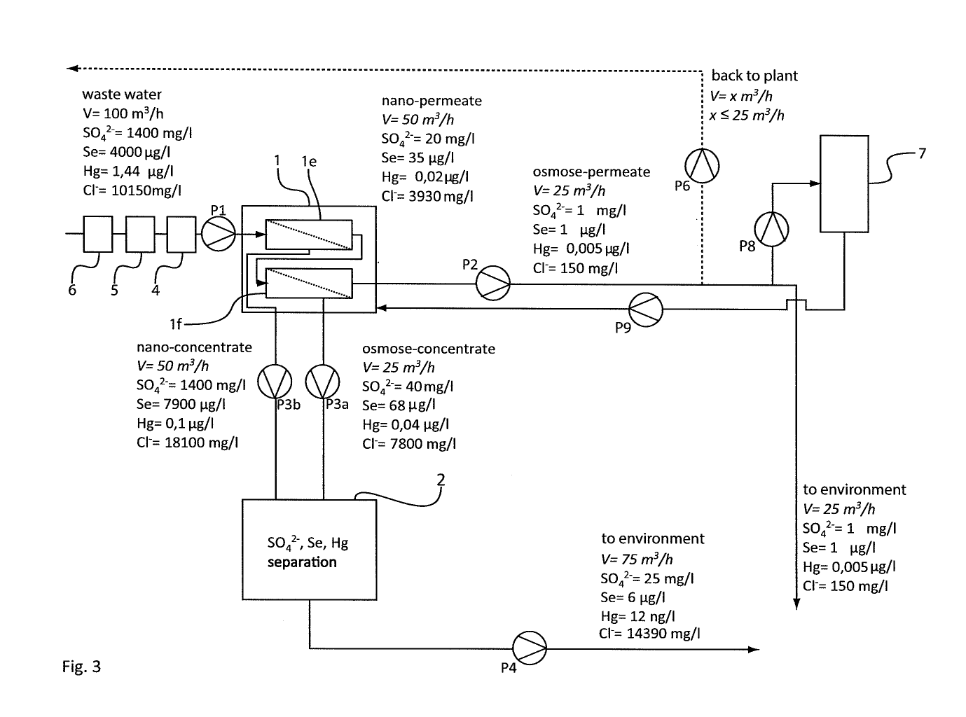

FIG. 3 illustrates a third preferred embodiment of the present invention. In this embodiment the high pressure separating apparatus 1 comprised of a nanofiltration device 1e and a reverse osmosis device 1f. Reference is made to Table 1 with regard to the concentrations of sulfate, chloride, mercury and selenium in the waste water, in the permeates and in the concentrates.

The waste water WW containing sulfate, chloride, mercury and selenium is shown in FIG. 3 and is supplied via a high pressure pump P1 to the high pressure separator, more specifically to the nano-filtration device 1e of the high pressure separator 1. The nano-filtration device 1e of the high-pressure separator 1 may comprise several parallel (not shown in FIG. 3) nanofiltration modules that can be switched on or off separately if needed. The nanofiltration device 1e splits the waste water into a nano-permeate volume and the nano-concentrate volume at a ratio of ≧50/≦50%. The nano-concentrate volume is supplied through a pump P3b to a device 2 for the separation of sulfate, selenium and mercury.

The nano-permeate with a reduced sulfate, chloride, mercury and selenium concentration is supplied as feed to the reverse osmosis device 1f, which separates the nanofiltration concentrate into a concentrate volume and a permeate volume, in which the reverse osmosis device 1f operates with a separation ratio of ≧50/≦50%. The concentrate volume of the reverse osmosis device 1f is supplied via a pump P3a to the device for the separation of sulfate, chloride, mercury and selenium. Due to the fact that the nanofiltration device 1e is already upstream of the reverse osmosis device 1f, and contributed to a greatly reduced sulfate concentrate, the sulfate separation in device 2 can be circumvented. The combined concentrates cleaned by device 2 are fed by a pump P4 to the environment.

The permeate volume of the reverse osmosis device 1f can be supplied by a pump P2 to the environment. Alternatively, the permeate volume can be returned completely or partly to the flue gas desulfurization system or to another upstream system or temporarily stored in tank 7, from which it can be fed via a high pressure pump P8 to the high pressure separator 1 for cleaning purposes as required.

Although with this method, the effluent to be purified is mitigated by only ≧25% (at a separation efficiency of ≧50% for the nanofiltration and reverse osmosis device), the levels of selenium and mercury in the (reverse osmosis) permeate leaving the high pressure separator are lower compared to those of the permeates from the first and second preferred embodiments of the present invention. This way more stringent discharge limits can be met if necessary, without any further elaborate and costly purification processes.

Alternatively, to achieve an improved cleaning effect, a plurality of reverse osmosis devices and nanofiltration devices may be connected in series in the high-pressure separator. Often, however, a “mixture” of a reverse osmosis and nanofiltration device is preferred because it can specifically target certain pollutants for separation.

Which preferred embodiment of the present invention is best depends on the contamination of the waste water.

Reduction of mercury and selenium concentrations with adsorbents

In an alternative or additional embodiment, one or more adsorbents either in combination or in sequence may be used to reduce the mercury and the selenium concentration of the concentrate volume. In some embodiments, the adsorbents may be used in lieu of or in combination with ion-exchange.

In one embodiment, the method comprises the steps of:

(A) providing a waste water of the flue gas desulfurization plant having a specific sulfate, chloride, mercury and selenium concentration,

(B) feeding the waste water through a high-pressure pump to a high pressure separator in which the waste water is separated into a permeate volume containing reduced, sulfate, chloride, mercury and selenium concentrations, and a concentrate volume,

(C) feeding the concentrate volume to a cleaning apparatus in which the mercury and the selenium concentration of the concentrate volume is reduced, wherein the cleaning apparatus include one or more adsorbents for reducing the mercury and the selenium concentration of the concentrate volume.

In still further embodiments, the invention may include in step (C), the steps of c1) precipitating BaSO₄ from the supplied concentrate volume through addition of a defined amount of Ba²⁺ ions to the concentrate volume, c2) separating the resulting BaSO_{4,} wherein a low solid concentrate volume is obtained, c3) passing the low solid concentrate volume in contact with absorbent agents to reduce one or more of the mercury and selenium concentration.

A wide variety of adsorbents may be used in the practice of the present invention. The following Table I summarizes characteristics of adsorbents that may be suitable in embodiments of the invention.

TABLE I
Representative adsorbent agents

| | | | | Mineral | Zeolites |
|---|---|---|---|---|---|
| Physical | | Activated | Hearth | Based | (aluminum |
| Property | Unites | Carbon | Coke | Sorbents | silicates) |
| Surface Area, | m²/g | 200-1300 | 270-330 | >40, >150 | >150-1000 |
| BET | | | | | |
| Grain Size (d50) | μm | 10-30 | 30-60 | 10-620 | 6 |
| Bulk Density | g/cm³ | 0.25-0.8 | 0.55 | | 0.5-2.5 |
| Pore Volume | ml/g | | | | 0.05-0.35 |

Suitable adsorbents may include, for example, carbon, activated coke, hearth oven coke made from bituminous coal (hard coal) and/or lignite coal (brown coal), polyamide, cellulose, zeolites, aluminum silicates, amended silicates, clay minerals and limestone based adsorbents, and combinations thereof.

The following Table II characterizes some physical properties of preferred adsorbents that may be used in embodiments of the present invention.

TABLE II
Representative physical properties of preferred adsorbent agents

| Physical | | Activated Carbon: | Activated Carbon: | Limestone based | Zeolithe: | Zeolithe: |
|---|---|---|---|---|---|---|
| Property | Units | Norit GL50 | EcoSorb XF | Sorbent: Sorbacal | Minsorb DX | Wessalith |
| Surface Area, | m²/g | 1050 | | 40 | >150 | 700 |
| BET | | | | | | |
| Grain Size (d50) | μm | 20-23 | 4.6 | | | |
| Bulk Density | g/cm³ | 0.45 | 0.25 | | | |
| Pore Volume | ml/g | | | 0.2 | | 0.29 |

1. A method for treating a sulfate-, chloride-, mercury- and selenium-containing waste water, the method comprises the steps of:
(A) providing a waste water having a specific sulfate, chloride, mercury and selenium concentration,
(B) feeding the waste water through a high-pressure pump to a high pressure separator in which the waste water is separated into a permeate volume containing reduced sulfate, chloride, mercury and selenium concentrations, and a concentrate volume,
(C) feeding the concentrate volume to a cleaning apparatus in which the mercury and the selenium concentration of the concentrate volume is reduced.

2. The method according to claim 1 for treating the wastewater, wherein a reverse osmosis device with at least one reverse osmosis module is used as the high pressure separator.

3. The method according to claim 1 for treating the wastewater, wherein a nanofiltration device with at least one nanofiltration module is used as the high pressure separator.

4. The method according to claim 2 for treating the waste water, wherein a nanofiltration and a reverse osmosis device are used as the separator, wherein
(B1) the waste water is supplied to the nanofiltration device, in which the waste water is separated into a nano-permeate volume and a nano-concentrate volume,
(B2) the nano-permeate volume is supplied to the reverse osmosis device, in which a permeate volume and a concentrate volume are separated, and the nano-concentrate volume and the concentrate volume are returned into the cleaning apparatus.

5. The method according to claim 3 for treating the waste water, wherein a nanofiltration and a reverse osmosis device are used as the separator, wherein
(B 1) the waste water is supplied to the nanofiltration device, in which the waste water is separated into a nano-permeate volume and a nano-concentrate volume,
(B2) the nano-permeate volume is supplied to the reverse osmosis device, in which a permeate volume and a concentrate volume are separated, and
the nano-concentrate volume and the concentrate volume are returned into the cleaning apparatus.

6. A method according to claim 2 for treating the waste water, wherein the reverse osmosis device and the nanofiltration device comprise several parallel process lines each having at least one reverse osmosis or nanofiltration module, wherein the lines can be switched on or off individually.

7. A method according to claim 3 for treating the waste water, wherein the reverse osmosis device and the nanofiltration device comprise several parallel process lines each having at least one reverse osmosis or nanofiltration module, wherein the lines can be switched on or off individually.

8. A method according to claim 4 for treating the waste water, wherein the reverse osmosis device and the nanofiltration device comprise several parallel process lines each having at least one reverse osmosis or nanofiltration module, wherein the lines can be switched on or off individually.

9. A method according to claim 2 for treating the waste water, wherein a reverse osmosis or nanofiltration module or a process line is automatically purged, triggered by predetermined parameters.

10. A method according to claim 3 for treating the waste water, wherein a reverse osmosis or nanofiltration module or a process line is automatically purged, triggered by predetermined parameters.

11. A method according to claim 4 for treating the waste water, wherein a reverse osmosis or nanofiltration module or a process line is automatically purged, triggered by predetermined parameters.

12. A method according to claim 6 for treating the waste water, wherein a reverse osmosis or nanofiltration module or a process line is automatically purged, triggered by predetermined parameters.

13. A method according to claim 9 for treating the waste water, wherein at least one part of the permeate volume and/or the nano-permeate volumes is temporarily stored and wherein one module or process line with at least one reverse osmosis or nanofiltration module is flushed with stored permeate volume.

14. A method according to claim 2 for treating the waste water, wherein solids are removed from the waste water before the waste water is separated into a permeate volume and a concentrate volume.

15. A method according to claim 3 for treating the waste water, wherein solids are removed from the waste water before the waste water is separated into a permeate volume and a concentrate volume.

16. A method according to claim 4 for treating the waste water, wherein solids are removed from the waste water before the waste water is separated into a permeate volume and a concentrate volume.

17. A method according to claim 6 for treating the waste water, wherein solids are removed from the waste water before the waste water is separated into a permeate volume and a concentrate volume.

18. The method according to claim 9 for treating the waste water, wherein solids are removed from the waste water before the waste water is separated into a permeate volume and a concentrate volume.

19. The method according to claim 13 for treating the waste water, wherein solids are removed from the waste water before the waste water is separated into a permeate volume and a concentrate volume.

20. The method according to claim 2 for treating the waste water, wherein an antiscaling agent and/or an acid is added to the waste water prior to being separated into a permeate volume and a concentrate volume.

21. The method according to claim 3 for treating the waste, wherein an antiscaling agent and/or an acid is added to the waste water prior to being separated into a permeate volume and a concentrate volume.

22. The method according to claim 4 for treating the waste water, wherein an antiscaling agent and/or an acid is added to the waste water prior to being separated into a permeate volume and a concentrate volume.

23. The method according to claim 6 for treating the waste water, wherein an antiscaling agent and/or an acid is added to the waste water prior to being separated into a permeate volume and a concentrate volume.

24. The method according to claim 9 for treating the waste water, wherein an antiscaling agent and/or an acid is added to the waste water prior to being separated into a permeate volume and a concentrate volume.

25. The method according to claim 13 for treating the waste, wherein an antiscaling agent and/or an acid is added to the waste water prior to being separated into a permeate volume and a concentrate volume.

26. The method according to claim 14 for treating the waste water, wherein an antiscaling agent and/or an acid is added to the waste water prior to being separated into a permeate volume and a concentrate volume.

27. The method according to claim 3 for treating the waste water, wherein sulfates and/or iron compounds are separated from the waste water before the waste water is separated into a permeate volume and a concentrate volume.

28. The method according to claim 4 for treating the waste water, wherein sulfates and/or iron compounds are separated from the waste water before the waste water is separated into a permeate volume and a concentrate volume.

29. The method according to claim 6 for treating the waste water, wherein sulfates and/or iron compounds are separated from the waste water before the waste water is separated into a permeate volume and a concentrate volume.

30. The method according to claim 9 for treating the waste water, wherein sulfates and/or iron compounds are separated from the waste water before the waste water is separated into a permeate volume and a concentrate volume.

31. The method according to claim 13 for treating the waste water, wherein sulfates and/or iron compounds are separated from the waste water before the waste water is separated into a permeate volume and a concentrate volume.

32. The method according to claim 14 for treating the waste water, wherein sulfates and/or iron compounds are separated from the waste water before the waste water is separated into a permeate volume and a concentrate volume.

33. The method according to claim 20 for treating the waste water, wherein sulfates and/or iron compounds are separated from the waste water before the waste water is separated into a permeate volume and a concentrate volume.

34. The method according to claim 1 for treating the waste water of a flue gas desulfurization plant, wherein at least a portion of the permeate volume and/or the nano-permeate volume is fed back into the flue gas desulfurization plant for further use.

35. The method according to claim 3 for treating the waste water in a flue gas desulfurization plant, wherein at least a portion of the permeate volume and/or the nano-permeate volume is fed back into the flue gas desulfurization plant for further use.

36. The method according to claim 4 for treating the waste water of a flue gas desulfurization plant, wherein at least a portion of the permeate volume and/or the nano-permeate volume is fed back into the flue gas desulfurization plant for further use.

37. The method according to claim 6 for treating the waste water of a flue gas desulfurization plant, wherein at least a portion of the permeate volume and/or the nano-permeate volume is fed back into the flue gas desulfurization plant for further use.

38. The method according to claim 9 for treating the waste water of a flue gas desulfurization plant, wherein at least a portion of the permeate volume and/or the nano-permeate volume is fed back into the flue gas desulfurization plant for further use.

39. The method according to claim 13 for treating the waste water of a flue gas desulfurization plant, wherein at least a portion of the permeate volume and/or the nano-permeate volume is fed back into the flue gas desulfurization plant for further use.

40. The method according to claim 14 for treating the waste water of a flue gas desulfurization plant, wherein at least a portion of the permeate volume and/or the nano-permeate volume is fed back into the flue gas desulfurization plant for further use.

41. The method according to claim 20 for treating the waste water of a flue gas desulfurization plant, wherein at least a portion of the permeate volume and/or the nano-permeate volume is fed back into the flue gas desulfurization plant for further use.

42. The method according to claim 26 for treating the waste water of a flue gas desulfurization plant, wherein at least a portion of the permeate volume and/or the nano-permeate volume is fed back into the flue gas desulfurization plant for further use.

43. The method according to claim 1 for treating the waste water of a flue gas desulfurization plant, wherein at least a portion of the waste water leaving the cleaning apparatus is returned to the flue gas desulfurization plant for further use.

44. A method according to claim 2 for treating the waste water of a flue gas desulfurization plant, wherein at least a portion of the waste water leaving the cleaning apparatus is returned to the flue gas desulfurization plant for further use.

45. The method according to claim 3 for treating the waste water of a flue gas desulfurization plant, wherein at least a portion of the waste water leaving the cleaning apparatus is returned to the flue gas desulfurization plant for further use.

46. The method according to claim 4 for treating the waste water of a flue gas desulfurization plant, wherein at least a portion of the waste water leaving the cleaning apparatus is returned to the flue gas desulfurization plant for further use.

47. The method according to claim 6 for treating the waste water in a flue gas desulfurization plant, wherein at least a portion of the waste water leaving the cleaning apparatus is returned to the flue gas desulfurization plant for further use.

48. The method according to claim 9 for treating the waste water of a flue gas desulfurization plant, wherein at least a portion of the waste water leaving the cleaning apparatus is returned to the flue gas desulfurization plant for further use.

49. The method according to claim 13 for treating the waste water of a flue gas desulfurization plant, wherein at least a portion of the waste water leaving the cleaning apparatus is returned to the flue gas desulfurization plant for further use.

50. The method according to claim 14 for treating the waste water of a flue gas desulfurization plant, wherein at least a portion of the waste water leaving the cleaning apparatus is returned to the flue gas desulfurization plant for further use.

51. The method according to claim 20 for treating the waste water of a flue gas desulfurization plant, wherein at least a portion of the waste water leaving the cleaning apparatus is returned to the flue gas desulfurization plant for further use.

52. The method according to claim 26 for treating the waste water of a flue gas desulfurization plant, wherein at least a portion of the waste water leaving the cleaning apparatus is returned to the flue gas desulfurization plant for further use.

53. The method according to claim 34 for treating the waste water of a flue gas desulfurization plant, wherein at least a portion of the waste water leaving the cleaning apparatus is returned to the flue gas desulfurization plant for further use.

54. The method according to claim 1 for treating the waste water, wherein, in the cleaning apparatus, the concentration of the mercury and selenium in the concentrate volume is reduced by
C1) precipitating BaSO₄ from the supplied concentrate volume through addition of a defined amount of Ba²⁺ ions to the concentrate volume,
C2) separating the resulting BaSO_{4,} wherein a low solid concentrate volume is obtained,
C3) passing the low solid concentrate volume through an ion exchanger for mercury removal, wherein the concentrate volume obtained has a reduced mercury concentration, and
C4) subsequently removing selenium and/or selenium compounds from the concentrate volume with a reduced mercury content.

55. The method according to claim 2 for treating the waste water, wherein, in the cleaning apparatus, the concentration of the mercury and selenium in the concentrate volume is reduced by
C1) precipitating BaSO₄ from the supplied concentrate volume through addition of a defined amount of Ba²⁺ ions to the concentrate volume,
C2) separating the resulting BaSO_{4,} wherein a low solid concentrate volume is obtained,
C3) passing the low solid concentrate volume through an ion exchanger for mercury removal, wherein the concentrate volume obtained has a reduced mercury concentration, and
C4) subsequently removing selenium and/or selenium compounds from the concentrate volume with a reduced mercury content.

56. The method according to claim 3 for treating the waste water, wherein, in the cleaning apparatus, the concentration of the mercury and selenium in the concentrate volume is reduced by
C1) precipitating BaSO₄ from the supplied concentrate volume through addition of a defined amount of Ba²⁺ ions to the concentrate volume,
C2) separating the resulting BaSO_{4,} wherein a low solid concentrate volume is obtained,
C3) passing the low solid concentrate volume through an ion exchanger for mercury removal, wherein the concentrate volume obtained has a reduced mercury concentration, and
C4) subsequently removing selenium and/or selenium compounds from the concentrate volume with a reduced mercury content.

57. The method according to claim 4 for treating the waste water, wherein, in the cleaning apparatus, the concentration of the mercury and selenium in the concentrate volume is reduced by
C1) precipitating BaSO₄ from the supplied concentrate volume through addition of a defined amount of Ba²⁺ ions to the concentrate volume,
C2) separating the resulting BaSO_{4,} wherein a low solid concentrate volume is obtained,
C3) passing the low solid concentrate volume through an ion exchanger for mercury removal, wherein the concentrate volume obtained has a reduced mercury concentration, and
C4) subsequently removing selenium and/or selenium compounds from the concentrate volume with a reduced mercury content.

58. The method according to claim 6 for treating the waste water, wherein, in the cleaning apparatus, the concentration of the mercury and selenium in the concentrate volume is reduced by
C1) precipitating BaSO₄ from the supplied concentrate volume through addition of a defined amount of Ba²⁺ ions to the concentrate volume,
C2) separating the resulting BaSO_{4,} wherein a low solid concentrate volume is obtained,
C3) passing the low solid concentrate volume through an ion exchanger for mercury removal, wherein the concentrate volume obtained has a reduced mercury concentration, and
C4) subsequently removing selenium and/or selenium compounds from the concentrate volume with a reduced mercury content.

59. The method according to claim 9 for treating the waste water, wherein, in the cleaning apparatus, the concentration of the mercury and selenium in the concentrate volume is reduced by
C1) precipitating BaSO₄ from the supplied concentrate volume through addition of a defined amount of Ba²⁺ ions to the concentrate volume,
C2) separating the resulting BaSO_{4,} wherein a low solid concentrate volume is obtained,
C3) passing the low solid concentrate volume through an ion exchanger for mercury removal, wherein the concentrate volume obtained has a reduced mercury concentration, and
C4) subsequently removing selenium and/or selenium compounds from the concentrate volume with a reduced mercury content.

60. The method according to claim 13 for treating the waste water, wherein, in the cleaning apparatus, the concentration of the mercury and selenium in the concentrate volume is reduced by
C1) precipitating BaSO₄ from the supplied concentrate volume through addition of a defined amount of Ba²⁺ ions to the concentrate volume,
C2) separating the resulting BaSO_{4,} wherein a low solid concentrate volume is obtained,
C3) passing the low solid concentrate volume through an ion exchanger for mercury removal, wherein the concentrate volume obtained has a reduced mercury concentration, and
C4) subsequently removing selenium and/or selenium compounds from the concentrate volume with a reduced mercury content.

61. The method according to claim 14 for treating the waste water, wherein, in the cleaning apparatus, the concentration of the mercury and selenium in the concentrate volume is reduced by
C1) precipitating BaSO₄ from the supplied concentrate volume through addition of a defined amount of Ba²⁺ ions to the concentrate volume,
C2) separating the resulting BaSO_{4,} wherein a low solid concentrate volume is obtained,
C3) passing the low solid concentrate volume through an ion exchanger for mercury removal, wherein the concentrate volume obtained has a reduced mercury concentration, and
C4) subsequently removing selenium and/or selenium compounds from the concentrate volume with a reduced mercury content.

62. The method according to claim 20 for treating the waste water, wherein, in the cleaning apparatus, the concentration of the mercury and selenium in the concentrate volume is reduced by
C1) precipitating BaSO₄ from the supplied concentrate volume through addition of a defined amount of Ba²⁺ ions to the concentrate volume,
C2) separating the resulting BaSO_{4,} wherein a low solid concentrate volume is obtained,
C3) passing the low solid concentrate volume through an ion exchanger for mercury removal, wherein the concentrate volume obtained has a reduced mercury concentration, and
C4) subsequently removing selenium and/or selenium compounds from the concentrate volume with a reduced mercury content.

63. The method according to claim 26 for treating the waste water, wherein, in the cleaning apparatus, the concentration of the mercury and selenium in the concentrate volume is reduced by
C1) precipitating BaSO₄ from the supplied concentrate volume through addition of a defined amount of Ba²⁺ ions to the concentrate volume,
C2) separating the resulting BaSO_{4,} wherein a low solid concentrate volume is obtained,
C3) passing the low solid concentrate volume through an ion exchanger for mercury removal, wherein the concentrate volume obtained has a reduced mercury concentration, and
C4) subsequently removing selenium and/or selenium compounds from the concentrate volume with a reduced mercury content.

64. The method according to claim 34 for treating the waste water, wherein, in the cleaning apparatus, the concentration of the mercury and selenium in the concentrate volume is reduced by
C1) precipitating BaSO₄ from the supplied concentrate volume through addition of a defined amount of Ba²⁺ ions to the concentrate volume,
C2) separating the resulting BaSO_{4,} wherein a low solid concentrate volume is obtained,
C3) passing the low solid concentrate volume through an ion exchanger for mercury removal, wherein the concentrate volume obtained has a reduced mercury concentration, and
C4) subsequently removing selenium and/or selenium compounds from the concentrate volume with a reduced mercury content.

65. A method according to claim 54 for treating the waste water, wherein selenium and/or selenium compounds are removed in step c4) by
adding a mixture of iron Fe (0) and Fe (II) as well as Fe (III) compounds to the concentrate volume with reduced mercury content, wherein preferably powdered Fe (0) is added,
subsequently adjusting the pH-value to between 6 and 8.5, preferably to between 7.0 and 8.0, and
separating selenium or selenium-containing solids from the concentrate volume with reduced mercury content.

66. The method according to claim 1 for treating the waste water, wherein in step (C) an adsorbent is used to reduce the mercury and the selenium concentration of the concentrate volume.

67. The method according to claim 66 for treating the waste water, wherein the adsorbent is selected from the group consisting of activated carbon, activated coke, hearth oven coke made from bituminous coal (hard coal) and/or lignite coal (brown coal), polyamide, cellulose, zeolites, aluminum silicates, amended silicates, clay minerals and limestone based adsorbents, and combinations thereof.

68. The use of a reverse osmosis device or a nanofiltration device for separating a waste water into a permeate volume with reduced sulfate, mercury and selenium concentrations and a concentrate volume with increased sulfate, chloride, mercury and selenium concentrations.
